(19) United States
(12) Patent Application Publication
(10) Pub. No.: US 2012/0039389 A1
(43) Pub. Date: Feb. 16, 2012

(54) DISTORTION WEIGHING

(75) Inventors: Rickard Sjoberg, Stockholm (SE); Kenneth Andersson, Gavle (SE); Xiaoyin Cheng, Munich (DE)

(73) Assignee: Telefonaktiebolaget L M Ericsson, Stockholm (SE)

(21) Appl. No.: 13/265,186

(22) PCT Filed: Apr. 27, 2010
(86) PCT No.: PCT/SE10/50463

§ 371 Date: Oct. 19, 2011

Related U.S. Application Data
(60) Provisional application No. 61/173,247, filed on Apr. 28, 2009.

(51) Int. Cl. H04N 7/26

(52) U.S. Cl. 375/240.03; 375/240.24; 375/E07.153; 375/E07.128

(57) ABSTRACT

A distortion representation is estimated for a macroblock (10) of a frame (1) by determining for each subgroup (30) of at least one pixel (20) out of multiple subgroups (30) in the macroblock (10), an activity value representative of a distribution of pixel values in a neighborhood (40) comprising multiple pixels (20) and encompassing the subgroup (30). Respective distortion weights are determined for the subgroups based on the activity values. These distortion weights are employed in order to estimate the distortion representation as a weighted combination of the pixel values of the macroblock (10) and reference pixel values for the macroblock (10). The distortion weights imply that different portions of a macroblock (10) will contribute more or less to the distortion representation as compared to other portions of the macroblock (10). The distortion representation will reduce ringing artifacts between high and low activity areas in a frame (1) during encoding.

### TECHNICAL FIELD

The present invention generally rates to distortion weighing for pixel blocks, and in particular such distortion weighing that can be used in connection with pixel block coding.

### BACKGROUND

Video coding standards define a syntax for coded representation of video data. Only the bit stream syntax for decoding is specified, which leaves flexibility in designing encoders. The video coding standards also allow for a compromise between optimizing image quality and reducing bit rate.

A quantization parameter can be used for modulating the step size of the quantizer or data compressor in the encoder. Generally, the quality and the bit rate of the coded video are dependent on the particular value of the quantization parameter employed by the encoder. Thus, a coarser quantization encodes a video scene using fewer bits but also reduces image quality. Finer quantization employs more bits to encode the video scene but typically at increased image quality.

Subjective video compression gains can be achieved with so called adaptive quantization where the quantization parameter (QP) is changed within video scenes or frames. Generally, in adaptive quantization a lower QP is used on areas that have smooth textures and a higher QP is used where the spatial activity is higher. This is a good idea since the human visual system will easily detect distortion in a smooth area, while the same amount of distortion in highly textured areas will go unnoticed.

U.S. Pat. No. 6,831,947 B1 discloses adaptive quantization of video frames based on bit rate prediction. The adaptive quantization increases the quantization in sectors of a video frame where coding artifacts would be less noticeable to the human visual system and decreases the quantization in sectors where coding artifacts would be more noticeable to the human visual system.

A limitation with the existing solutions of adaptively lowering or increasing the QP value is that the QP adaptivity can only be changed on macroblock basis, i.e. blocks of 16×16 pixels, according to the current video coding standards.

FIG. 1 illustrates the problems arising due to this limitation in QP adaptivity. In the prior art solutions, the whole macroblock has to be smooth in order for it to be classified as smooth and get a lower QP value. This can result in clearly visible ringing around high activity objects on smooth background, as illustrated in FIG. 1. The grey, homogenous portion of the figure represents parts of the frame where the macroblocks are classified as smooth according to the prior art. The ringing effects are evident around the high activity object represented by a football player on smooth grass background.

A straightforward solution would be to include those macroblocks that are partly smooth in the group of macroblocks that are assigned a lower QP value. However, lowering the QP for all these macroblocks would cost very many bits, thereby increasing the bit rate too much in order to be useful in practice.

There is therefore a need for a solution that enables reduction of the ringing artifacts of the prior art techniques and that can be used in connection with video coding.

### SUMMARY

It is a general objective to provide an improved distortion representation.

It is a particular objective to provide a distortion representation that can be used in connection with encoding of pixel blocks of a frame.

Briefly, a distortion representation is estimated for a pixel block of a frame. The pixel block is partioned into multiple, preferably non-overlapping, subgroups, where each such subgroup comprises at least one pixel of the pixel block. An activity value or representation is determined for each subgroup where the activity value is representative of a distribution of pixel values in a pixel neighborhood comprising multiple pixels and encompassing the subgroup.

A distortion weight is determined for the subgroup based on the activity value. The distortion weights determined for the subgroups of the pixel group are employed together with the pixel values of the pixel block and reference pixel values, such as reconstructed or predicted pixel values, for the pixel block to estimate the distortion representation for the pixel block. The distortion weights therefore entail that pixels of the pixel block will contribute more to the distortion representation as compared to other pixels of the pixel block.

A device for estimating a distortion representation comprises an activity calculator configured to calculate, for each subgroup of a pixel block, an activity value. A weight determiner determines respective distortion weights for the subgroups based on the respective activity values. The distortion representation for the pixel block is then estimated or calculated by a distortion estimator based on the multiple distortion weights, the pixel values of the pixel block and the reference pixel values.

The distortion representation can advantageously be employed in connection with encoding a frame for the purpose of selecting appropriate encoding mode for a macroblock. In such a case, a macroblock activity is calculated for each macroblock of a frame as being representative of the distribution of pixel values within the macroblock. The macroblocks of the frame are categorized into at least two categories based on the macroblock activities, such as low activity macroblocks and high activity macroblocks. The low activity macroblocks are assigned a low quantization parameter value, whereas the high activity macroblocks are assigned a high quantization parameter value.

Activity values are determined for each subgroup of a macroblock as previously mentioned. The subgroups are classified as low activity or high activity subgroups based on the activity values. The distortion weights of the subgroups in low activity macroblocks and high activity subgroups of high activity macroblocks are set to be equal to a defined factor. However, distortion weights for low activity subgroups in high activity macroblocks are instead determined to be larger than the defined factor and are preferably determined based on the quantization parameter value assigned to the respective macroblocks.

The distortion weights are employed to determine a distortion representation for a macroblock that in turn is used together with a rate value for obtaining a rate-distortion value for the macroblock. The macroblock is then pseudo-encoded according to various encoding modes and for each such mode a rate-distortion value is calculated. An encoding mode to use for the macroblock is selected based on the rate-distortion values.

An embodiment also relates to an encoder for encoding a frame. The encoder comprises a block activity calculator that calculates respective macroblock activities for the macroblocks in the frame and a block categorizer that categorizes the macroblocks into at least two categories, such as low activity or high activity macroblock based on the macroblock activities. A quantization selector selects quantization parameter values for the macroblocks based on the macroblock activities. The subgroup-specific activity values are determined by an activity calculator and employed by a subgroup categorizer for classifying the subgroups as low activity or high activity subgroups. A weight determiner determines the distortion weights for subgroups in low activity macroblocks and high activity subgroups of high activity macroblocks to be equal to a defined factor, whereas low activity subgroups in high activity macroblocks get distortion weights that are larger than the defined factor.

A macroblock is then pseudo-encoded by the encoder according to each of the available encoding modes. For each such encoding mode, a rate-distortion value is determined based on the weighted distortion representation and a rate value for that particular encoding mode. A mode selector selects the most suitable encoding mode, i.e. the one that minimizes the rate-distortion value for a macroblock. The encoder then encodes the macroblock according to this selected encoding mode.

The distortion weights enable, when used in connection with encoding of frames, a reduction of ringing and motion drag artifacts at a much lower bit cost than what can be achieved by reducing the quantization parameter value.

### BRIEF DESCRIPTION OF THE DRAWINGS

The invention, together with further objects and advantages thereof, may best be understood by making reference to the following description taken together with the accompanying drawings, in which:

FIG. 1 is a figure illustrating problems with ringing effects according to prior art techniques;

FIG. 2 is a flow diagram illustrating a method of generating a distortion representation for a pixel block according to an embodiment;

FIG. 3 is a schematic illustration of a frame with a pixel block comprising multiple pixels according to an embodiment;

FIG. 4 is a flow diagram illustrating an embodiment of the activity value determining step of FIG. 2;

FIG. 5 schematically illustrates an embodiment of providing multiple pixel neighborhoods for the purpose of determining an activity value;

FIG. 6 schematically illustrates another embodiment of providing multiple pixel neighborhoods for the purpose of determining an activity value;

FIG. 7 is a figure illustrating advantageous effect of an embodiment in comparison to the prior art of FIG. 1;

FIG. 8 schematically illustrates different embodiments of determining activity values;

FIG. 9 is a flow diagram illustrating an additional, optional step of the estimating method in FIG. 2;

FIG. 10 is a flow diagram illustrating additional, optional steps of the estimating method in FIG. 2;

FIG. 11 is a flow diagram illustrating additional, optional steps of the estimating method in FIG. 2;

FIG. 12 is a flow diagram illustrating a method of encoding a frame of macroblocks according to an embodiment;

FIG. 13 schematically illustrates the application of an embodiment in connection with an adaptive quantization scheme;

FIG. 14 schematically illustrates the concept of motion estimation for inter coding according to an embodiment;

FIG. 15 is a schematic block diagram of a distortion generating device according to an embodiment;

FIG. 16 is a schematic block diagram of an embodiment of a threshold provider of the distortion estimating device in FIG. 15;

FIG. 17 is a schematic block diagram of another embodiment of a threshold provider of the distortion estimating device in FIG. 15;

FIG. 18 is a schematic block diagram of an encoder according to an embodiment; and

FIG. 19 is a schematic block diagram of an encoder structure according to an embodiment.

### DETAILED DESCRIPTION

Throughout the drawings, the same reference numbers are used for similar or corresponding elements.

The embodiments generally relate to processing of pixel blocks of a frame where the characteristics of the pixels within a pixel block are allowed to reflect and affect a distortion representation for the pixel block. As a consequence, the embodiments provide an efficient technique of handling pixel blocks comprising both smooth pixel portions with low variance in pixel characteristics or values and pixel portions having comparatively higher activity in terms of higher variance in pixel characteristics.

The novel distortion representation of the embodiments provides a valuable tool during encoding and decoding of pixel blocks and frames for instance by selecting appropriate encoding or decoding mode, conducting motion estimation and reducing the number of encoding or decoding modes investigated during the encoding and decoding.

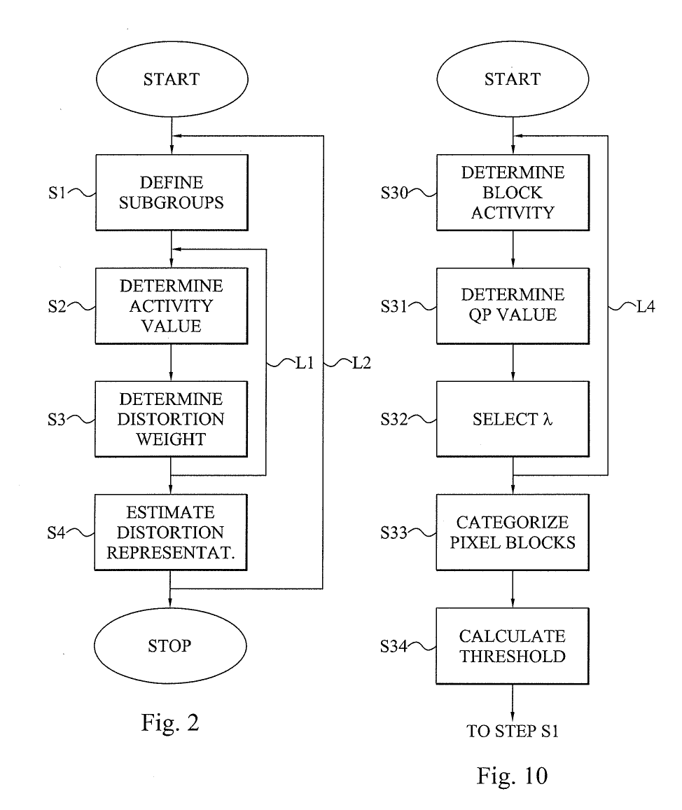

In order to simplify understanding of the embodiments, a description of a general embodiment first follows with reference to FIG. 2. The figure is a flow diagram of a method of estimating a distortion representation for a pixel block of a frame.

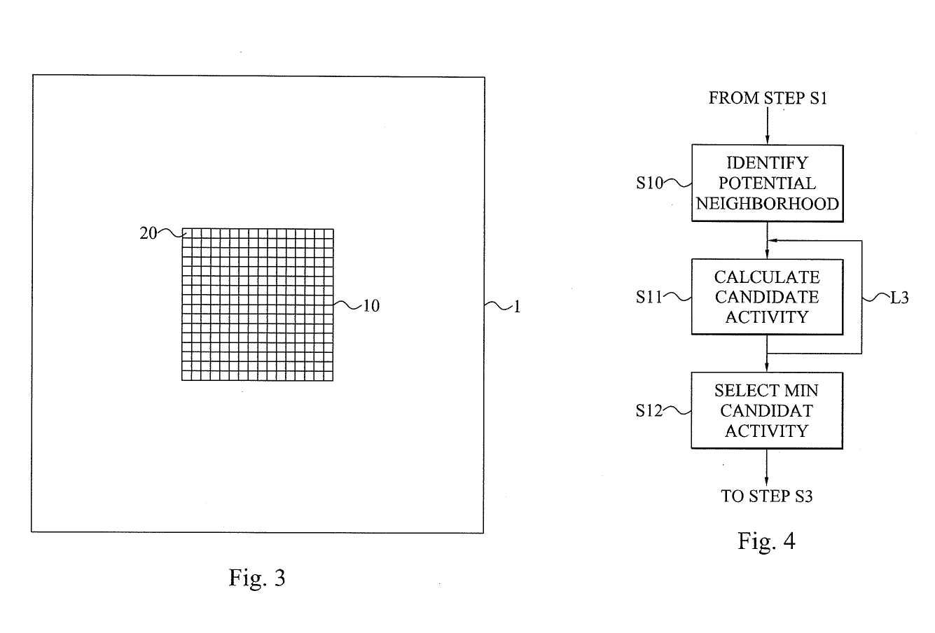

According to the embodiments a frame 1 as illustrated in FIG. 3 is composed of a number of pixel blocks 10 each comprising multiple pixels 20, where each pixel has a respective pixel characteristic or value, such as a color value, optionally consisting of multiple components. As is known in the art, each pixel typically comprises a color value in the red, green, blue (RGB) format and can therefore be represented as RGB-triplet. However, during encoding and decoding of frames the RGB values of the pixels are typically converted from the RGB format into corresponding luminance (Y) and chrominance (UV) values, such as in the YUV format. A common example is to use YUV 4:2:0, where the luminance is in full resolution and the chrominance components use half the resolution in both horizontal and vertical axes. The pixel value as used herein can therefore be a luminance value, a chrominance value or both luminance and chrominance values. Alternatively, a pixel value in the RGB format or in another color or luminance-chrominance format can alternative be used according to the embodiments.

The pixel block 10 preferably comprises 2^{α}×2^{β} pixels, where α,β are positive integers equal to or larger than one and preferably α=β. The pixel block 10 is preferably the smallest non-overlapping entity of the frame 1 that is collectively handled and processed during encoding and decoding of the frame 1. A preferred implementation of such a pixel block 10 is therefore a so-called macroblock comprising 16×16 pixels 20. As is well-known in the art, a macroblock 10 is the smallest entity that is assigned an individual quantization parameter (QP) during encoding and decoding with adaptive QP. Hence, the embodiments are particularly suitable for estimating a distortion representation for a pixel block 10 that is a macroblock. In the following the present invention will be further described with reference to macroblock as an illustrative and preferred example of pixel block.

The frame 1 is preferably a frame 1 of a video sequence but can alternatively be a frame 1 of an (individual) still image.

The first step S1 of the method in FIG. 2 involves defining multiple subgroups of the macroblock (pixel block). Each of these subgroups comprises at least one pixel of the macroblock. As is further described herein a subgroup can comprise a single pixel of the macroblock or multiple, i.e. at least two, pixels of the macroblock. However, the subgroup is indeed a true subgroup, which implies that the number of pixels in a subgroup is less than the total number of pixels of the macroblock.

A next step S2 determines an activity value for a subgroup defined in step S1. The activity value is representative of a distribution of pixel characteristics or values in a pixel neighborhood comprising multiple pixels and encompassing the subgroup. The pixel neighborhood is a group of pixels having a pre-defined size in terms of number of included pixels and is preferably at least partly positioned inside the macroblock to encompass the pixel or pixels of the subgroup. The pixel neighborhood can have a pre-defined size that is equal to the size of the subgroup if the subgroup comprises multiple pixels. In such a case, there is a one-to-one relationship between subgroup and pixel neighborhood. However, it is generally preferred if the pixel neighborhood is larger than the subgroup to thereby encompass more pixels of the frame besides the at least one pixel of the current subgroup.

The activity value can be any representation of the distribution of the pixel values in the pixel neighborhood. Non-limiting examples include the sum of the absolute differences in pixel values for adjacent pixels in the same row or column in the pixel neighborhood.

The following step S3 determines a distortion weight for a subgroup based on the activity value determined for the subgroup in step S2. The steps S2 and S3 are performed for each subgroup of the macroblock defined in step S1, which is schematically illustrated by the line L1. As a consequence, each subgroup is thereby assigned a respective distortion weight and where the distortion weight is determined based on the activity value generated for the particular subgroup. Furthermore, the distortion weights are preferably determined so that a distortion weight for a subgroup having an activity value representing a first activity is lower than a distortion weight for a subgroup having an activity value representing a second activity that is comparatively lower than the first activity. Expressed differently, the distortion weight for a high activity subgroup is preferably lower than the distortion weight for a low activity subgroup, where the activity of the subgroup is represented by the activity value.

The distortion weights enable an individual assessment and compensation of pixel activities within a macroblock since each subgroup of at least one pixel is given a distortion weight. Additionally, in a preferred embodiment any low activity subgroups within a macroblock are assigned distortion weights that are comparatively higher than the distortion weights for any high activity subgroups within the macroblock. This implies that the low activity subgroups of the macroblock will be weighted higher in the determination of distortion representation and are therefore given a higher level of importance for the macroblock.

Once each subgroup has been assigned a respective distortion weight in step S3 the method continues to step S4 where the distortion representation for the macroblock is estimated based on the multiple distortion weights from step S3, the pixel values of the macroblock and reference pixel values for the macroblock. The distortion representation, D, is thereby a function of the distortion weights, the pixel values and the reference values: D=kᵢⱼ×f(p, q, n, i, j), where p denotes the current frame, q denotes the reference frame for the current frame, n is the number of the current macroblock within the current frame, i,j are the pixel coordinates of a subgroups within the macroblock and kᵢⱼ denotes the distortion weight for subgroup having pixel coordinates (i,j).

The reference pixel values are pixel values of a reference macroblock that is employed as a reference to the current macroblock. This means that the distortion representation is a distortion or error value indicative of how much the reference pixel values differ from the current and preferably original pixel values of the macroblock. The particular reference macroblock that is employed in step S4 depends on the purpose of the distortion representation. For instance, during encoding of a frame different encoding modes are tested for a macroblock and for each such encoding modes the original pixel values of the macroblock are first encoded according to the mode to get a candidate encoded macroblock and then the candidate encoded macroblock is decoded to get reconstructed pixel values.

The differences between the original pixel values and the reconstructed pixel values are utilized together with the distortion weights in estimating the distortion representation. Thus, reconstructed pixel values obtained following encoding and decoding is an example of reference pixel values according to the embodiments. An alternative application of the distortion representation is during motion estimation with the purpose of finding a suitable motion vector for an inter (P or B) coded macroblock. In such case, the distortion representation is a weighted difference between the original pixel values of the macroblock and the motion-compensated pixels of a reference macroblock in a reference frame. As a consequence, such motion-compensated pixels are another example of reference pixel values according to the embodiments. Thus, any predicted, motion-compensated, reconstructed or otherwise reference pixel values that are employed as reference values for a macroblock during encoding or decoding can be regarded as reference pixel values as used herein. The relevant feature herein is that a distortion or error representation that reflects the differences in pixel values between a macroblock and a reference macroblock, such as reconstructed, predicted or motion-compensated macroblock, is estimated.

The estimation of the distortion representation in step S4 is conducted in a radically different way than according to the prior art. In the art, the distortion representation is estimated directly on the difference in pixel values between the macroblock and the reference macroblock. There is then no weighting of the differences and in particular no weighting of the differences that reflects the activities in different portions of the macroblock.

The distortion representation of the embodiments thereby allows different pixels in the macroblock to be weighted differently when determining the distortion representation. As a consequence, the contribution to the distortion representation will be different for pixels and subgroups having different distortion weights and thereby for pixels and subgroups having different activities.

The weighting of the pixel value differences improves the encoding and decoding of the macroblock by reducing ringing and motion drag artifacts in the border between high and low activity areas of a frame.

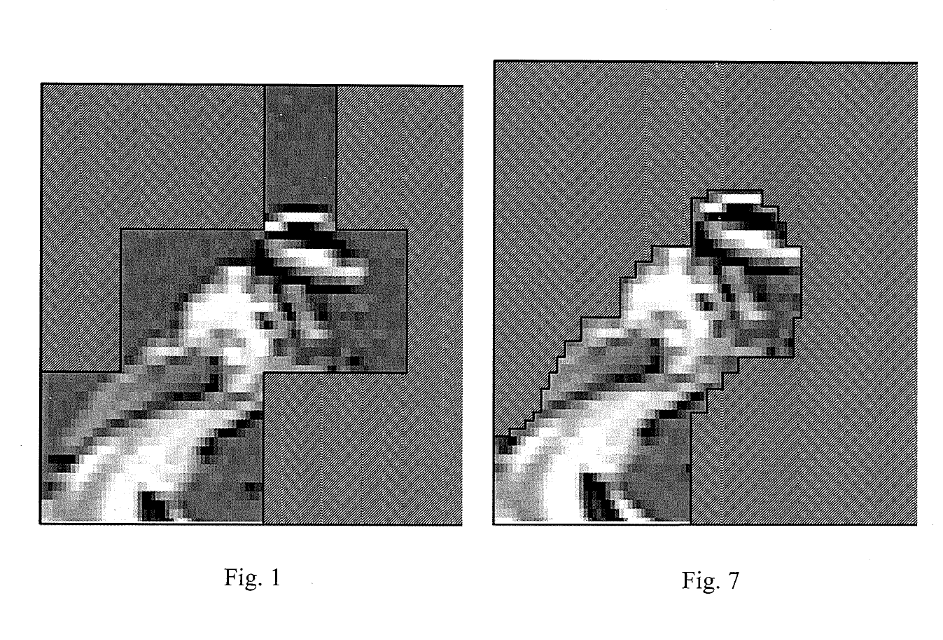

The operation of steps S1-S4 can be conducted once for a single macroblock within the frame. However, the method is advantageously conducted for multiple macroblocks of the frame, which is schematically illustrated by the line L2. In an embodiment, all macroblocks is assigned a distortion representation as estimated in step S4. In an alternative approach only selected macroblocks within a frame are processed as disclosed by steps S1-S4. These macroblocks can, for instance, be those macroblocks that comprise both high and low activity pixel areas and are typically found in the border of high and low activity areas of a frame, such as illustrated in FIG. 1. This means that for other macroblocks in the frame the traditional non-weighted distortion value can instead be utilized.

The subgroups defined in step S1 of FIG. 2 can in an embodiment be individual pixels. Thus, in such a case pixel-specific activity values or pixel activities are determined in step S2. If the pixel block is a macroblock of 16×16 pixels, step S1 will, thus, define 256 subgroups. Usage of individual pixels as subgroups generally improves the performance of determining activity values, distortion weights and the distortion representation since it is then possible to compensate for and regard individual variations in pixel values within the macroblock.

In order to reduce the complexity in the determination of activity values the subgroups defined in step S1 can include more than one pixel. In such a case, the subgroups are preferably non-overlapping subgroups and preferably of 2^{m}×2ⁿ pixels, wherein m,n are zero (if both are zero each subgroup comprises a single pixel as mentioned above), one, two or three. In a preferred embodiment, the subgroups defined in step S1 are non-overlapping sub-groups of 2^{m}×2^{m} pixels. If the size of the pixel block, e.g. macroblock, is larger than 16×16 pixels, the parameters m,n can have larger values than four. Generally, for a quadratic pixel block of 2^{o}×2^{o} pixels, the subgroups can consist of 2^{m}×2^{m} pixels, for a quadratic subgroup, where m is zero or a positive integer with the proviso that m<o.

This grouping of multiple neighboring pixels together into a subgroup and determining a single activity value for all of the pixels in the subgroup significantly reduces the complexity and the memory requirements. For instance, utilizing subgroups of 2×2 pixels instead of individual pixels reduces the complexity and memory requirements by 75%. Having larger subgroups, such as 4×4 pixels or 8×8 pixels for a macroblock of 16×16 pixels, reduces the complexity even further.

FIG. 4 is a flow diagram illustrating an embodiment of the determination of the activity value in FIG. 2. The method continues from step S1 of FIG. 2. A next step S10 identifies a potential pixel neighborhood comprising multiple pixels and encompassing a current subgroup. The potential pixel neighborhood preferably has a pre-defined shape and size in terms of the number of pixels that it encompasses. The size of the pixel neighborhood is further dependent on the size of the subgroups defined in step S1 since the pixel neighborhood should at least be of the same size as the subgroup in order to encompass the at least one pixel of the subgroup. It is generally preferred, in terms of improving the quality of the activity value, to have a pixel neighborhood that has a size larger than the size of the subgroup in order enclose at least some more pixels of the macroblock than the subgroup. This is further a requisite if the subgroups only comprise a single pixel each. However, the larger the size of the pixel neighborhood the more complex the calculation of the activity value becomes.

A pixel neighborhood is preferably identified as a block of 2^{a}×2^{b} pixels encompassing the subgroup, wherein a,b are positive integers equal to or larger than one. Non-limiting examples of pixel neighborhoods that can be used according to the embodiments include 16×16, 8×8, 4×4 and 2×2 pixels. It is though not necessary that the pixel neighborhood is quadratic but can instead be a differently shaped block such as 32×8 and 8×32 pixels. These two blocks have the same number of pixels as a quadratic 16×16 block. It is indeed possible to mix pixel neighborhoods of different shapes such as 16×16, 32×8 and 8×32. Since all these pixel neighborhoods have the same number of pixels, no normalization or scaling of the activity value is needed. Rectangular blocks can be used instead or as a complement also for the other sizes, such as 16×4 and 4×16 pixels for an 8×8 block, 8×2 and 2×8 pixels for a 4×4 block. It is actually possible to utilize pixel neighborhoods of different number of pixels since normalization based on the number of pixels per pixel neighborhood is easily done when calculating the activity value.

A computational simple embodiment of calculating the activity value is to place the pixel neighborhood so that the current subgroup is positioned in the centre of the pixel neighborhood. This will, however, result in a high activity value for those subgroups in a smooth area (low activity) that are close to a non-smooth area (high activity). A more preferred embodiment is therefore conducted as illustrated in steps S11 and S12 of FIG. 4.

Step S11 calculates a candidate activity value representative of a distribution of pixel values within the pixel neighborhood when the pixel neighborhood is positioned in a first position to encompass the subgroup. The pixel neighborhood is then positioned in another position that encompasses the subgroup and a new candidate activity value is calculated for the new position. Thus, in an embodiment multiple different positions for the pixel neighborhood relative the subgroup are tested and a candidate activity value is calculated for each of these positions, which is schematically illustrated by the line L3. This means that the position of a subgroup within a potential pixel neighborhood is different from the respective positions of the subgroup within each of the other potential pixel neighborhoods defined in step S10 and tested in step S11.

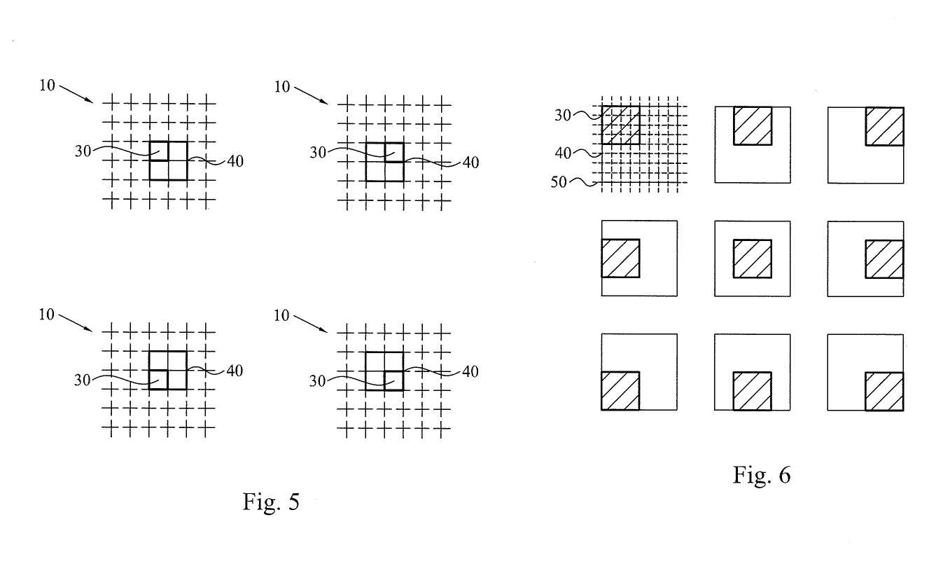

FIG. 5 schematically illustrates this concept. The four figures illustrate a portion of a macroblock 10 with a subgroup 30 consisting, in this example, of a single pixel. The pixel neighborhood 40 has a size of 2×2 pixels in FIG. 5 and the figures illustrate the four different possible positions of the pixel neighborhood 40 relative the subgroup 30 so that the single pixel of the subgroup 30 occupies one of the four possible positions within the pixel neighborhood 40.

In an embodiment of step S11 all possible positions of the pixel neighborhood relative the subgroup is tested as illustrated in FIG. 5. In order to reduce the computational complexity not all possible pixel neighborhood positions are investigated. For instance, all pixel neighborhoods that have its upper left corner at an odd horizontal or vertical coordinate could be omitted. This is equivalent to say that the pixel neighborhoods for which a candidate activity value is computed are placed on a 2×2 grid. Other such grid sizes could instead be used such as 4×4, 8×8 grids and so on. Generally, a pixel neighborhood in the form of a block of 2^{a}×2^{b} pixels can be restricted to positions on a 2^{c}×2^{d} grid in the frame, where c,d are positive integers equal to or larger than one, and c≦a and d≦b.

FIG. 6 illustrates this concept of limiting the number of possible positions of a pixel neighborhood 40 relative a subgroup 30. In this example the subgroup 30 comprises 4×4 pixels and the pixel neighborhood 40 is a block of 8×8 pixels. The figures also illustrates a grid 50 of 2×2 pixels. The usage of a 2×2 grid implies that the pixel neighborhood 40 can only be positioned according to the nine illustrated positions when encompassing the subgroup 30. This means that the number of pixel neighborhood positions is reduced from 25 to 9 in this example.

Once all available potential pixel neighborhood positions have been tested in step S11 and a candidate activity value is calculated for each of the tested potential pixel neighborhoods the method continues to step S12. This step S12 selects the smallest or lowest candidate activity value as the activity value for the subgroup. The method then continues to step S3 of FIG. 2, where the distortion weight is determined based on the selected candidate activity value.

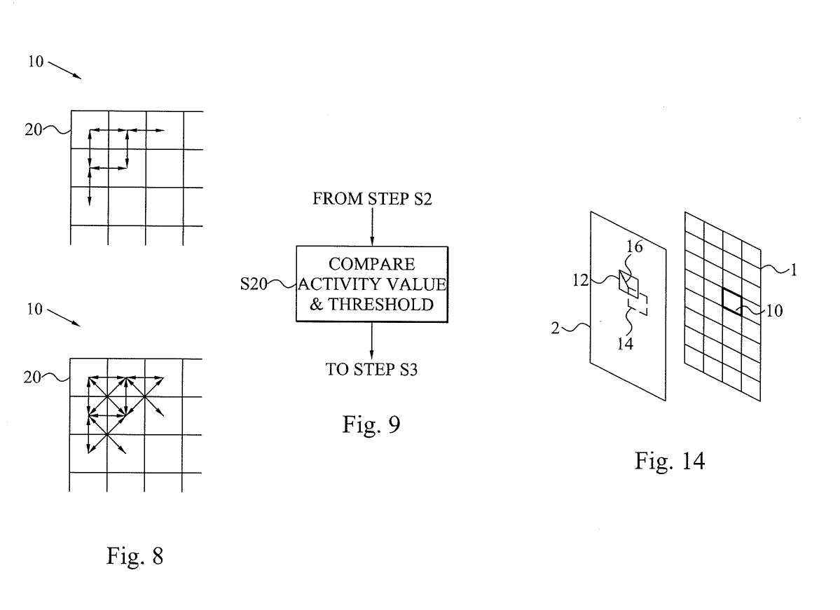

As has been previously described the (candidate) activity value is representative of a distribution of the pixel values within a (potential) pixel neighborhood. Various activity values are possible and can be used according to the embodiments. In an example, the absolute differences between adjacent pixels in the row and columns are summed to get activity value. This corresponds to:

$$Activity = {\sum }_{x = 0}^{{2}^{a} - 2} {\sum }_{y = 0}^{{2}^{b} - 1} \vert {Y}_{x , y} - {Y}_{x + 1 , y} \vert + {\sum }_{x = 0}^{{2}^{a} - 1} {\sum }_{y = 0}^{{2}^{b} - 2} \vert {Y}_{x , y} - {Y}_{x , y + 1} \vert ,$$

where denotes the pixel value of pixel at position (x,y) within the pixel neighborhood comprising 2^{a}×2^{b} pixels. This is schematically illustrated in the upper part of FIG. 8. This activity value is purely spatial and gives low activity values to smooth subgroups. The activity value is only sensitive to horizontal and vertical pixel value differences. An alternative activity value is sensitive to pixel differences in more directions, i.e. also diagonals:

$$Activity = {\sum }_{x = 0}^{{2}^{a} - 2} {\sum }_{y = 0}^{{2}^{b} - 1} \vert {Y}_{x , y} - {Y}_{x + 1 , y} \vert + {\sum }_{x = 0}^{{2}^{a} - 1} {\sum }_{y = 0}^{{2}^{b} - 2} \vert {Y}_{x , y} - {Y}_{x , y + 1} \vert + {\sum }_{x = 0}^{{2}^{a} - 2} {\sum }_{y = 0}^{{2}^{b} - 2} \vert {Y}_{x , y} - {Y}_{x + 1 , y + 1} \vert + {\sum }_{x = {2}^{a} - 1}^{1} {\sum }_{y = 0}^{{2}^{b} - 2} \vert {Y}_{x , y} - {Y}_{x - 1 , y + 1} \vert$$

The lower part of FIG. 8 illustrates this embodiment of activity value that is based on a sum of absolute differences in pixel values of vertically, horizontally and diagonally neighboring or adjacent pixels in the pixel neighborhood.

A simple modification of the above described activity value embodiments is not to take the absolute differences in pixel values but rather the squared differences in pixel values. Actually any value that is reflective of the distribution of pixel values within the pixel neighborhood can be used according to the embodiments.

Other subgroup activity values could be used and the embodiments are not only limited to the spatial activity mentioned above.

The distortion weight determined in step S3 of FIG. 2 based on the activity value for a subgroup is typically determined as a function of the activity value. In an embodiment, the distortion weight is determined to be linear to the activity value. However, also other functions can be considered such as exponential and logarithmic.

Generally the distortion weight for a high activity subgroup should be lower than the distortion weight for a low activity subgroup:

kᵢⱼ≦V, subgroupᵢⱼεhigh activity

kᵢⱼ>V, subgroupᵢⱼεlow activity

where V is some defined constant, preferably one.

The function to use for determining the distortion weight based on the activity value can be constructed to also be based on an adaptive QP method employed for assigning QP values to macroblocks in the frame. For instance, assume that macroblock M and macroblock N are neighboring macroblocks in the frame. The adaptive QP method has further assigned a low QP value to macroblock M and a high QP value to macroblock N. Macroblock M therefore corresponds to a smooth area of the frame with little spatial activity and pixel value variations, whereas macroblock N has higher activity and therefore higher variance in pixel values. However, some of the pixels in macroblock N that are close to the macroblock M actually belong to the smooth (background) area of the frame and therefore have low pixel activity. Then the function from activity value to distortion weight could be such that the effects of the distortion weights correlate with the lambda effects by quantization parameters used for macroblocks M and N. As is well known in the art a rate-distortion term J=D+λ×bits is often employed in the encoding/decoding, where D is the distortion for a macroblock, bits denotes the number of bits required for encoding the macroblock and λ is a Lagrange multiplier and defines the relative contribution of distortion and bits to the rate-distortion term. λ is typically a function of the quantization parameter value used for encoding the macroblock. In the art, each QP value therefore has a corresponding lambda value that often is stored in a table. The value to use for each QP is experimentally found and the lambda values are typically monotonically increasing with increasing QP value.

Assume in this example that macroblock M is encoded with a quantization parameter value QP_{M} and macroblock N is encoded with a quantization parameter value QP_{N}. These quantization parameter values in turn imply that the following lambda values are selected for the two macroblocks λ_{M} and λ_{N}, respectively. In order to get the same effect on the lambda as the quantization effect gives, the distortion weight for the low activity pixels in macroblock N is then

$$\frac{{λ}_{N}}{{λ}_{M}} .$$

Alternatively, the distortion weight could be defined as

$$f \frac{{λ}_{N}}{{λ}_{M}} ,$$

where f is a factor equal to or larger than one. The distortion weights for the high activity pixels in the macroblock N are then set to be ˜1.0.

In an alternative approach the macroblock N is instead coded with a lower quantization parameter value, QP_{L}<QP_{N}. The distortion weight to use for the low activity pixels in macroblock N becomes

$$f \frac{{λ}_{L}}{{λ}_{M}} .$$

In this case the distortion weight for the high activity pixels in the macroblock N are preferably not set equal to the defined constant of 1 but is instead

$$f \frac{{λ}_{L}}{{λ}_{N}} .$$

The selected quantization parameter value QP_{L}, is preferably QP_{M}<QP_{L}<QP_{N} and can be selected to be

$${QP}_{L} = \frac{{QP}_{M} + {QP}_{N}}{2}$$

but does not have to be halfway between QP_{M} and QP_{N}.

Actually any function that allows determination of distortion weights based on the activity values can be used according to the embodiments as long as an activity value representing a low activity results in a larger distortion weight as compared an activity value representing a comparatively higher activity.

In a particular embodiment, it can be possible to use a subgroup size of 8×8 pixels, a grid of 8×8 pixels and a pixel neighborhood of 8×8 pixels. This corresponds to macroblock activities but done for 8×8 blocks. For this special case you may change the adaptive QP method to work on 8×8 blocks instead of 16×16 blocks. A virtual QP value is assigned to each 8×8 block and the macroblock QP value is set depending on the virtual 8×8 QP values. If 3 of 4 8×8 blocks are assigned to the same QP value, the macroblock QP value used may be set to the majority 8×8 QP value. The distortion weight for those 8×8 subgroups should be 1 but the distortion weight for the remaining subgroup should be modified to match the virtual QP as described above in the example with macroblocks M and N. If half of the 8×8 subgroups have one virtual QP value and half have another, the macroblock QP value might be set to the lower virtual QP value or the higher QP value or a QP ivalue n between. For all cases the distortion weight should be used to compensate the difference between macroblock QP value and virtual QP value as described above.

In order to reduce the number of different values for the distortion weights, at least one threshold can be used to divide the activity values into a limited number of categories, where each category is assigned a distortion weight. For instance and with a single threshold, activity values above such a threshold get a certain distortion weight and subgroups and pixels having activity values below the threshold get another distortion weight. This concept is schematically illustrated in FIG. 9. The method continues from step S2 of FIG. 2. In a next step S20 the activity value determined for a subgroup is compared with at least one activity threshold. The method then continues to step S3 of FIG. 2, where the distortion weight for the subgroup is determined based on the comparison.

In a particular embodiment, a single activity threshold is employed to thereby differentiate subgroups and pixels as low activity subgroups, i.e. having respective activity values below the activity threshold, and high activity subgroups, i.e. having respective activity values exceeding the activity threshold.

With a single activity threshold, the distortion weight for the high activity subgroups is preferably equal to a defined constant, preferably one. Low activity subgroups can then have the distortion weight determined to be larger than the defined constant. In a particular embodiment, the distortion weight is determined based on the quantization parameter value determined for the macroblock. In such a case, the distortion weight can be a function based on the Lagrange multipliers assigned to the current macroblock and a neighboring macroblock in the frame as previously described, such as

$$k = f \times \frac{{λ}_{N}}{{λ}_{M}} .$$

The embodiments are not limited to using a single activity threshold but can also be used in connection with having multiple different activity thresholds to thereby get more than two different categories of subgroups.

The at least one activity threshold can be fixed, i.e. be equal to a defined value. This means that one and the same value per activity threshold will be used for all macroblocks in a frame and preferably all frames within a video sequence.

In an alternative approach the value(s) of the at least one activity threshold is determined in connection with the adaptive QP method. With reference to FIG. 10, a respective block activity is determined in the adapative QP method for each macroblock in the frame in step S30. The block activity is representative of the distribution of pixel values within the macroblock. The block activities are employed for determining quantization parameters for the macroblocks in step S31 according techniques well-known in the art. Each macroblock is further assigned in step S32 a Lagrange-multiplier or lambda value that is preferably defined based on the quantization parameter and the macroblock mode of the macroblock as previously described. The steps S30-S32 are preferably performed for all macroblocks within the frame, which is schematically illustrated by the line L4. The macroblocks are then divided in step S33 into multiple categories based on the respective quantization parameter values determined for the macroblocks, preferably based on the block activities. The macroblock having the highest block activity is then identified for preferably each category or at least a portion of the categories. The at least one activity threshold can then be determined based on the activity values determined for the identified macroblock in step S34. The method then continues to step S1 of FIG. 2, where the distortion representation is estimated as previously described.

In a particular embodiment, the value of an activity threshold can be set to the average or median activity value of the macroblock with the highest block activity for that category. In an alternative approach, the activity threshold is set to the average or median activity value of the macroblock with the highest block activity for a category and the macroblock with the lowest block activity for the next category having higher QP value. This approach implies that most pixels stay in their categories and thereby will get a distortion weight that is typically equal to or close to the other pixels in this category.

In an alternative approach, the at least one activity threshold is dynamically determined so that a fixed percentage of the subgroups or pixels will be having activity values that exceed or are below the activity threshold. In such a case, the macroblocks of the frame are divided into different categories based on their respective quantization parameter values that are preferably determined based on the respective block activities. The respective percentages of macroblocks that end up into the different categories are then calculated and these percentages are used to calculate the at least one activity threshold. For instance, assume two macroblock classes with 60% of the macroblock end up in the category containing the lowest activity macroblocks. In such a case, the value of the (single) activity threshold could then be selected so that 60% of the subgroups with lowest activity values will have activity values that fall below the activity threshold.

In order to simplify implantation the distortion weights can be set to multiples of 2 to avoid multiplications. The distortion weights can therefore be

$$\frac{1}{{2}^{t}} , 1 , {2}^{t}$$

for different positive integer values t. This means that the weighting can be implemented with shifts only.

The distortion representation estimated in step S4 is preferably determined as

$$D = {\sum }_{i = 0}^{M - 1} {\sum }_{j = 0}^{N - 1} {k}_{ij} {\vert {p}_{ij} - {q}_{ij} \vert}^{n}$$

wherein pᵢⱼ denotes a pixel value at pixel position i,j within a pixel block (macroblock), qᵢⱼ denotes a reference pixel value at pixel position i, j, kᵢⱼ denotes the distortion weight of the subgroup at pixel position i, j, n is a positive number equal to or larger than one and the pixel block comprises M×N pixels, preferably 16×16 pixels. The sum of squared differences, i.e. n=2, is the most common distortion metric in the art. An alternative distortion metric that is commonly used in the art is the sum of the absolute differences, i.e. n=1. This latter distortion metric, i.e. SAD modified with the distortion weights, is advantageously used in connection with motion estimation.

FIG. 7 is the corresponding drawing as illustrated in FIG. 1 but processed according to an embodiment. As is seen in the figure, the embodiments as disclosed herein reduce the ringing effect around high activity objects on the smooth background.

The distortion representation of the embodiments can be utilized in connection with macroblock encoding and decoding as a parameter of the rate-distortion parameter J=D+λ×bits. In such a case, the Lagrange multiplier or lambda value is determined for the macroblock preferably based on the quantization parameter value assigned to the macroblock during an adaptive QP procedure. The rate parameter is representative of the bit cost for an encoded version of the macroblock generated based on the quantization parameter. The rate-distortion value or Lagrange cost function is then obtained as the weighted sum of the distortion representation of the embodiments and the rate value weighted with the Lagrange multiplier.

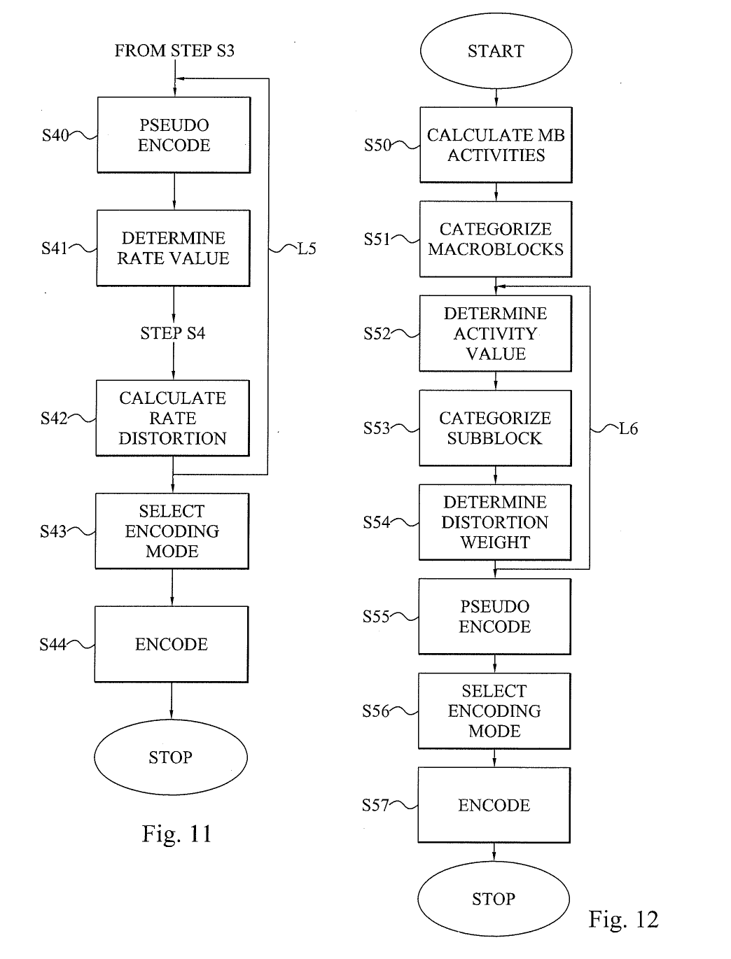

The rate-distortion value determined according to above can be used in connection with encoding macroblocks of a frame. In such a case, the method continues from step S3 of FIG. 2, where the distortion weights have been determined. Additionally, steps S30-S32 of FIG. 10 have preferably also been conducted so that the adaptive QP method has calculated block activities for the macroblocks, determined QP values and selected Lagrange multipliers. The method continues to step S40 of FIG. 11. This step pseudo-encodes the macroblock according to one of a set of multiple available encoding modes. The rate value for the encoded macroblock is determined in step S41. The method then continues to step S4 of FIG. 2, where the distortion representation for the macroblock is estimated. In this case, the reference pixel values employed in step S4 are the reconstructued pixel values obtained following decoding the pseudo-encoded macroblock. Once the distortion representation is estimated the method continues to step S42, where the rate-distortion value is calculated for the macroblock for the tested encoding mode. The operation of steps S40-S42 is then repeated for all the other available encoding modes, which is schematically illustrated by the line L5.

As is well known in the art, a macroblock can be encoded according to various modes. For instance, there are several possible intra coding modes, the skip mode and a number of inter coding modes available for macroblocks. For intra coding different coding directions are possible and in inter coding, the macroblock can be split differently and/or use different reference frames or motion vectors. This is all known within the field of video coding.

The result of the multiple operations of steps S40 to S42 is that a respective rate-distortion value is obtained from each of the tested encoding modes. The particular encoding mode to use for the macroblock is then selected in step S43. This encoding mode is preferably the one that has the lowest rate-distortion value among the modes as calculated in step S42. An encoded version of the macroblock is then obtained by encoding the macroblock in step S44 according to the selected encoding mode.

The usage of distortion weights according to the embodiments for the estimation or calculation of the distortion representation implies that at least some of the macroblocks of a frame will get different rate-distortion values for some of the tested encoding modes. In particular those macroblocks that are present in the frame in the border between high and low activity areas will get significantly different rate-distortion values for some of the encoding modes. As a consequence, a more appropriate encoding mode will be selected for these macroblocks, which will be seen as reduction in ringing and motion drag artifacts but at a much lower bit-cost than lowering the QP values for these macroblocks.

In standard video coding the selected encoding mode from step S43 is transmitted to the decoder. However, in decoder side mode estimation a decoding mode to use for an encoded macroblock is derived in the decoder. Embodiments as disclosed herein can also be used in such a scenario. One way of determining the decoding mode in the decoder is to use template matching. In template matching a previously decoded area outside the current macroblock is used similar as the original macroblock in standard video coding.

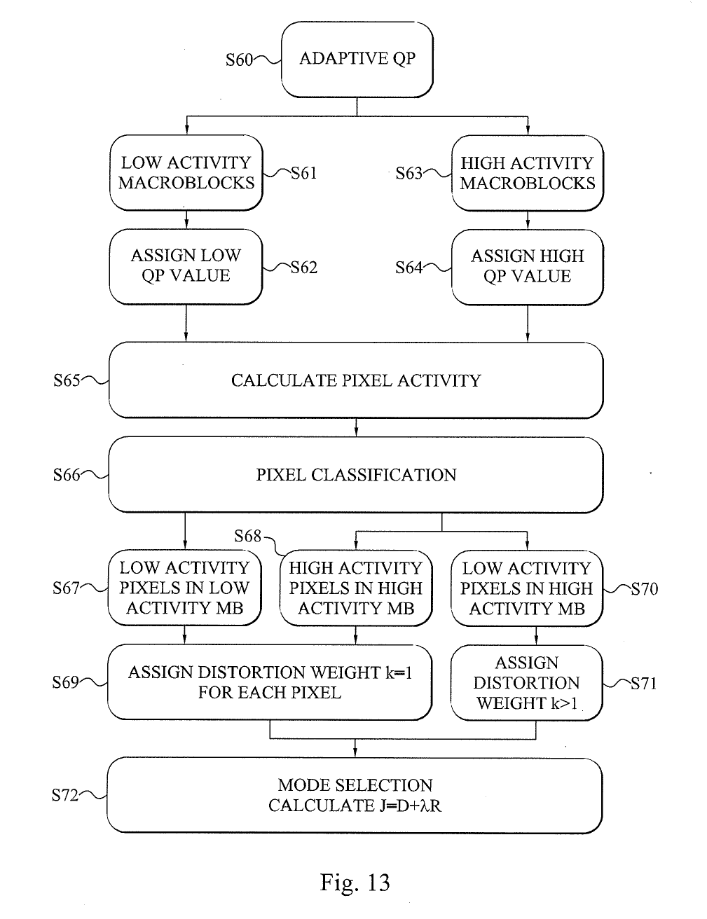

The distortion representation of the embodiments can advantageously be used in combination with adaptive QP during encoding a frame. Such an application of the distortion representation will be described further with reference to FIGS. 12 and 13. In a method of encoding a frame comprising multiple macroblocks, a respective macroblock activity is calculated in step S50 for each macroblock. As previously described the macroblock activity is representative of the distribution of pixel values within the macroblock and can, for instance, be defined as

$$Activity = {\sum }_{x = 0}^{14} {\sum }_{y = 0}^{15} \vert {Y}_{x , y} - {Y}_{x + 1 , y} \vert + {\sum }_{x = 0}^{15} {\sum }_{y = 0}^{14} \vert {Y}_{x , y} - {Y}_{x , y + 1} \vert$$

$$or$$

$$Activity = {\sum }_{x = 0}^{14} {\sum }_{y = 0}^{15} \vert {Y}_{x , y} - {Y}_{x + 1 , y} \vert + {\sum }_{x = 0}^{15} {\sum }_{y = 0}^{14} \vert {Y}_{x , y} - {Y}_{x , y + 1} \vert + {\sum }_{x = 0}^{14} {\sum }_{y = 0}^{14} \vert {Y}_{x , y} - {Y}_{x + 1 , y + 1} \vert + {\sum }_{x = 15}^{1} {\sum }_{y = 0}^{14} \vert {Y}_{x , y} - {Y}_{x - 1 , y + 1} \vert .$$

The adaptive QP method in S60 of the encoding then categories the multiple macroblocks in step S51. In an illustrative embodiment the macroblocks are categorized as at least low activity macroblocks S61 or high activity macroblocks S63 based on the respective macroblock activities. Thus, the division of the macroblocks into multiple categories can be conducted in terms of defining two categories one for low activity macroblocks and the other for high activity macroblocks. This procedure can of course be extended further to differentiate between more than two categories of macroblocks.

The macroblocks are further assigned quantization parameter values in the adaptive QP according to the category that they are assigned to in step S51. Thus, a macroblock categorized in step S51 as a low activity macroblock is assigned a low QP value S62 and a macroblock belonging to the high activity category is assigned a high QP value S64 that is larger than the low QP value.

The processing of the following steps S52-S54 is preferably conducted for each macroblock, which is schematically illustrated by the line L6. Step S52 determines, for each subgroup of at least one pixel out of multiple subgroups in the macroblock, an activity value representative of the distribution of pixel values in a pixel neighborhood comprising multiple pixels and encompassing the subgroup S65. This step S52 is basically conducted in the same way as step S2 of FIG. 2 and is not further described herein. Each of the multiple subgroups in the macroblock is then categorized or classified in step S53/S66 as low activity subgroup S67, S70 or high activity subgroup S68 based on the respective activity values determined in step S52. The classification of subgroups in step S53 can be conducted according to any of the previously described techniques, for instance by comparing the activity values with an activity threshold.

The next step S54 determines distortion weights for the subgroups. In a particular embodiment of step S54, subgroups belonging to a macroblock categorized as a low activity macroblock S67 are preferably assigned a distortion weight that is equal to a defined constant, such as one S69. This defined constant is preferably also assigned as distortion weight to subgroups in high activity macroblocks that are classified as high activity subgroups S68. However, distortion weights that are larger than the defined constant S71 are instead determined for subgroups classified as low activity subgroups and belonging to a high activity macroblock S70. The distortion weights for these low activity subgroups can advantageously be calculated as previously described based on the QP value assigned to the current high activity macroblock and preferably also the QP value assigned to a neighboring macroblock in the frame.

Thereafter follows an encoding mode selection procedure that is conducted based on the rate-distortion value previously described S72. Thus, the macroblocks are pseudo-encoded in step S55 according to the various available encoding modes and a rate-distortion value is calculated based on the distortion weights for each candidate encoding mode. The encoding mode that minimizes the rate-distortion value for a macroblock is selected in step S56 and used for encoding the particular macroblock in step S57. Note that the operation of steps S55-S57 is typically conducted separately for each macroblock, which implies that not all macroblock of a frame must be encoded with the same macroblock type or mode.

The distortion weights and the subgroup activities employed for determining the distortion weights can also be used for reducing the number of encoding modes to be tested for a macroblock. Thus, the distribution of subgroup activities or distortion weights for a macroblock can make it prima facie evident that the macroblock will not be efficiently encoding using a particular encoding mode, i.e. will result in a very high rate-distortion value if encoded using that particular encoding mode. In such a case, the number of available encoding modes can therefore be reduced to thereby significantly reduce the complexity of the encoding process and speed up the macroblock encoding.

The distortion weights of the embodiments can also be used for other applications besides evaluating candidate macroblock modes for encoding. For instance, the distortion weights can also be employed for evaluating motion vector candidates for macroblock splits in e.g. H.264. The same distortion weights can be used and the motion vector(s) that minimizes rate-distortion value is selected. FIG. 14 schematically illustrates this concept. A current macroblock 10 in a current frame 1 is to be inter coded and a motion vector 16 defining the motion between the position 14 the macroblock 10 would have had in a reference frame 2 to the macroblock prediction 12 in the reference frame 2 is determined. In such a case, the reference pixel values used in the estimation of the distortion representation are the motion-compensated pixel values of the macroblock prediction 12.

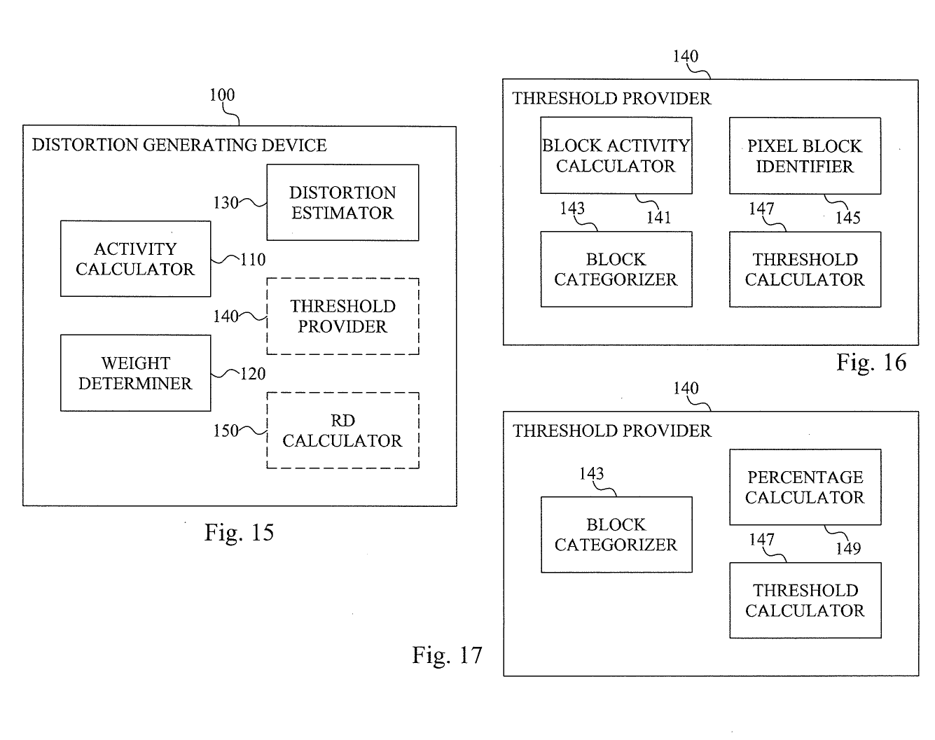

FIG. 15 is a schematic block diagram of an embodiment of a distortion estimating device 100. The distortion estimating device 100 comprises an activity calculator 110 configured to calculate an activity value for each subgroup comprising at least one pixel out of multiple subgroups in a pixel block, such as macroblock. The activity value is preferably representative of a distribution of pixel values in a pixel neighborhood comprising multiple pixels and encompassing the subgroup.

A weight determiner 120 uses the activity value determined by the activity calculator 110 for determining a distortion weight for the subgroup. The activity calculator 110 and the weight determiner 120 are preferably operated to determine an activity value and a distortion weight for each subgroup in the pixel block.

The distortion estimating device 100 also comprises a distortion estimator 130 configured to estimate a distortion representation for the pixel block based on the multiple distortion weights determined by the weight determiner 120 for the subgroups of the pixel block, pixel values of the pixel block and reference pixel values for the pixel block.

The activity calculator 110 is preferably configured to calculate a candidate activity value for each of multiple potential pixel neighborhoods relative the subgroup as previously described. The activity calculator 110 then preferably selects the smallest of these multiple candidate activity values as the activity value to use for the subgroup. The potential pixel neighborhoods are blocks of pixels where the position of the subgroup within the block of a pixel neighborhood is different from the respective positions of the subgroup within the other pixel neighborhoods. Grids for the purpose or reducing the number of positions of the potential pixel neighborhood relative the subgroup as previously described can be utilized by the activity calculator 110.

The weight determiner 120 preferably determines the distortion weight for a subgroup based on a comparison of the activity value of the subgroup with at least one activity threshold. In such a case, the distortion estimating device 100 may optionally comprise a threshold provider 140 that is configured to provide the at least one activity threshold that is employed by the weight determiner 120.

FIG. 16 is a block diagram illustrating a possible implementation embodiment of the threshold provider 140. The threshold provider 140 comprises a block activity calculator 141 configured to calculate a respective block activity for each pixel block in the frame. A block categorizer 143 divides the pixel blocks in the frame into multiple categories based on respective quantization parameters assigned for the pixel blocks based on the block activities. The threshold provider 140 also comprises a pixel block identifier 145 configured to identify the pixel block having the highest block activity in at least one of the multiple categories. A threshold calculator 147 then calculates the at least one activity threshold based on the activity values calculated for the pixel block(s) identified by the pixel block identifier 145.

FIG. 17 is a block diagram illustrating another implementation embodiment of the threshold provider 140. The threshold provider 140 comprises a block categorizer 143 that operates in the same way as the corresponding block categorizer in FIG. 16. A percentage calculator 149 is configured to calculate the respective percentage of the pixel blocks in the frame that belong to each of the multiple categories defined by the block categorizer 143. The threshold calculator 147 calculates in this embodiment the at least one activity threshold based on the respective percentages calculated by the percentage calculator according to techniques as previously described.

The weight determiner 120 can then be configured to determine the distortion weight to be equal to a defined constant, such as one, if the activity value determined for a subgroup exceeds an activity threshold and determine the distortion weight based on the QP value assigned to the pixel block if the activity value instead is below the activity threshold. In this latter case, the distortion weight can be determined based on the ratio of the Lagrange multiplier for the current pixel block and the Lagrange multiplier for a neighboring pixel block in the frame as previously described.

The distortion estimating device 100 may optionally also comprise a rate-distortion (RD) calculator 150 configured to calculate a rate-distortion value for the pixel block based on the distortion representation from the distortion estimator 130 and a rate value representative of a bit cost of an encoded version of the pixel block.

The distortion estimating device 100 can be implemented in hardware, software or a combination of hardware and software. If implemented in software the distortion estimating device 100 is implemented as a computer program product stored on a memory and loaded and run on a general purpose or specially adapted computer, processor or microprocessor. The software includes computer program code elements or software code portions effectuating the operation of the activity calculator 110, the weight determiner 120 and the distortion estimator 130 of the distortion estimating device 100. The other optional but preferred devices as illustrated in FIG. 15 may also be implemented as computer program code elements stored in the memory and executed by the processor. The program may be stored in whole or part, on or in one or more suitable computer readable media or data storage means such as magnetic disks, CD-ROMs, DVD disks, USB memories, hard discs, magneto-optical memory, in RAM or volatile memory, in ROM or flash memory, as firmware, or on a data server.

The distortion estimating device 100 can advantageously be implemented in a computer, a mobile device or other video or image processing device or system.

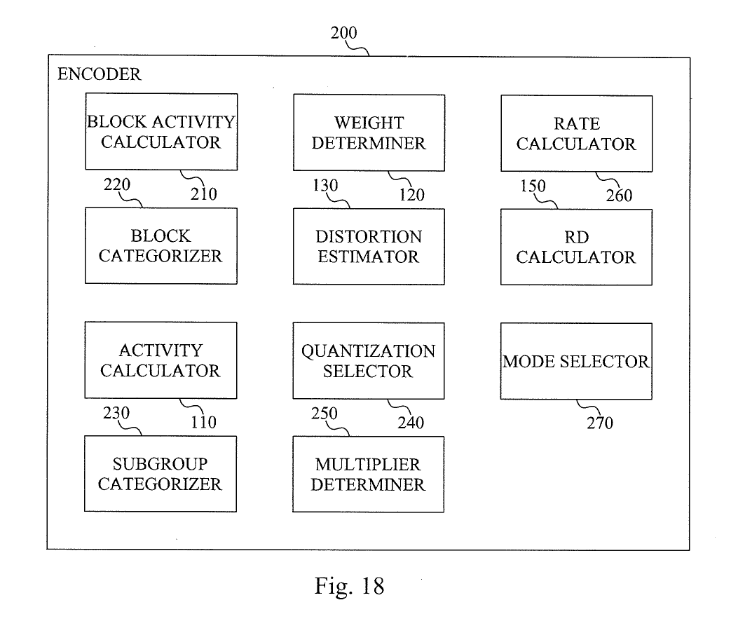

An embodiment also relates to an encoder 200 as illustrated in FIG. 18. The encoder 200 is then configured to pseudo-encode a pixel block according each encoding mode of a set of multiple available encoding modes. The encoder 200 comprises, in this embodiment, a distortion estimating device 100 as illustrated in FIG. 15, i.e. comprising the activity calculator 110, the weight determiner 120, the distortion estimator 130 and the rate-distortion calculator 150. In such a case, the rate-distortion calculator 150 calculates a respective rate-distortion value for each of the multiple available encoding modes as previously described. A mode selector 270 of the encoder 200 selects an encoding mode that minimizes the rate-distortion value among the multiple available encoding modes. The encoder 200 then generates an encoded version of the pixel block by encoding the pixel block according to the encoding mode selected by the mode selector 270.

In an alternative embodiment of the encoder 200 a block activity calculator 210 is configured to calculate a macroblock activity for each macroblock in the frame. A block categorizer 220 categorizes the multiple macroblocks as at least low activity macroblocks or high activity macroblocks based on the macroblock activities calculated by the block activity calculator 210.

The encoder 200 also comprises a quantization selector 240 implemented for selecting a respective QP value for each of the macroblocks based on the macroblock activities. In such a case, a low activity macroblock is assigned a low QP value, whereas a high activity macroblock is assigned a comparatively higher QP value. The activity calculator 110 operates for calculating activity values for the subgroups of the macroblocks as previously described. A subgroup categorizer 230 classifies the subgroups based on the activity values as low activity subgroup or high activity subgroup.

The weight determiner 120 assigns a distortion weight equal to a defined factor or constant to those subgroups that belong to a categorized low activity macroblock and the high activity subgroups of a high activity macroblock. However, the distortion weights for the low activity subgroups in high activity macroblocks are instead determined to be larger than the defined factor and are preferably calculated based on the QP values determined for these macroblocks by the quantization selector 240.

A multiplier determiner 250 is implemented in the encoder 200 for determining Lagrange multipliers for the macroblocks based on the QP values determined by the quantization selector 240. The encoder 200 also comprises a rate calculator 260 configured to derive a rate value representative of the bit size or cost of an encoded version of a macroblock. The rate-distortion calculator 150 then generates a rate-distortion value for a macroblock based on the distortion representation from the distortion estimator 130, the Lagrange multiplier from the multiplier determiner 250 and the rate value from the rate calculator 260. Such a rate-distortion value is calculated for each tested encoding mode and the mode selector 270 can then select the encoding mode to use for a macroblock based on the different rate-distortion values, i.e. preferably selecting the encoding mode that results in the smallest rate-distortion value.

The encoder 200 illustrated in FIG. 18 can be implemented in software, hardware or a combination thereof. In the former case, the encoder 200 is implemented as a computer program product stored on a memory and loaded and run on a general purpose or specially adapted computer, processor or microprocessor. The software includes computer program code elements or software code portions effectuating the operation of the units 110-130, 150, 210-270 of the encoder 200. The program may be stored in whole or part, on or in one or more suitable computer readable media or data storage means such as magnetic disks, CD-ROMs, DVD disks, USB memories, hard discs, magneto-optical memory, in RAM or volatile memory, in ROM or flash memory, as firmware, or on a data server.

The encoder 200 can advantageously be implemented in a computer, a mobile device or other video or image processing device or system.

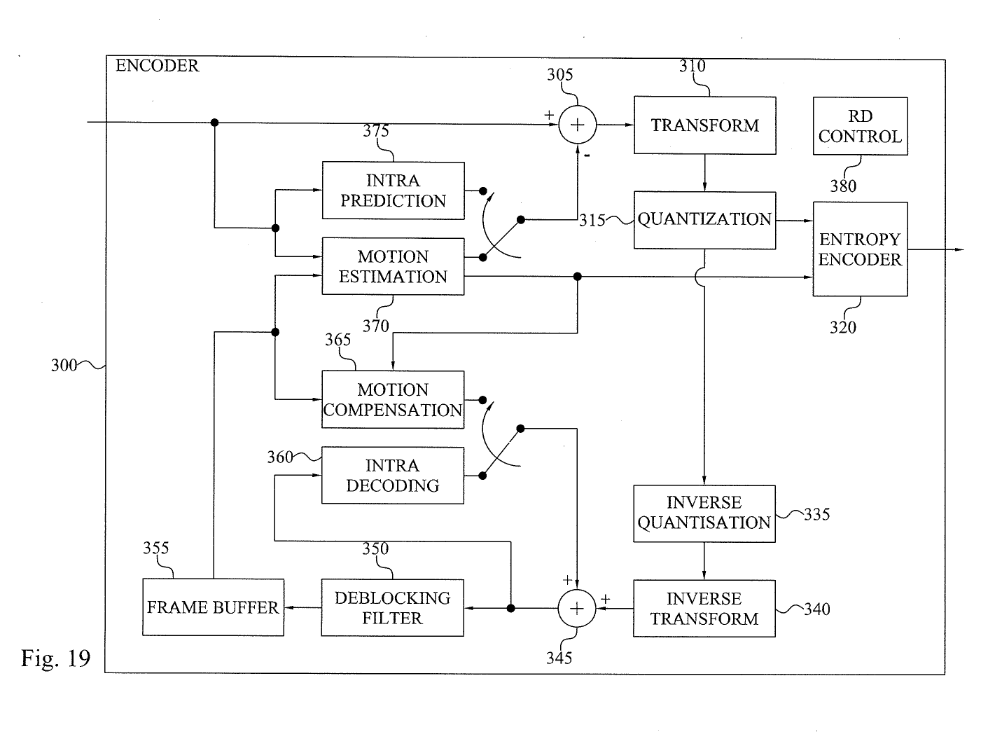

FIG. 19 is a schematic block diagram of an encoder structure 300 according to another embodiment. The encoder 300 comprises a motion estimation unit or estimator 370 configured for an inter predicted version of a pixel block and an intra prediction unit or predictor 375 for generating a corresponding intra predicted version of the pixel block. The pixel block prediction and the reference pixel block are forwarded to an error calculator 305 that calculates the residual error as the difference in property values between the original pixel block and the reference or predicted pixel blocks. The residual error is transformed, such as by a discrete cosine transform 310, and quantized 315 followed by entropy encoding 320.

The transformed and quantized residual error for the current pixel block is also provided to an inverse quantizer 335 and inverse transformer 340 to retrieve an approximation of the original residual error.

This original residual error is added in an adder 345 to the reference pixel block output from a motion compensation unit 365 or an intra decoding unit 360 to compute the decoded block. The decoded block can be used in the prediction and coding of a next pixel block of the frame. This decoded pixel block can optionally first be processed by a deblocking filter 350 before entering a frame 355 become available to the intra predictor 375, the motion estimator 370 and the motion compensation unit 365.

The encoder 300 also comprises a rate-distortion controller 380 configured to select the particular encoding mode for each pixel block as previously described herein.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. A method of generating a distortion representation for a pixel block of a frame comprising:
defining multiple subgroups of said pixel block, where each subgroup comprises at least one pixel of said pixel block;
determining, for each subgroup of said multiple subgroups, an activity value representative of a distribution of pixel values in a pixel neighborhood comprising multiple pixels and encompassing said subgroup;
determining, for each subgroup of said multiple subgroups, a distortion weight based on said activity value determined for said subgroup; and
estimating a distortion representation for said pixel block based on said multiple distortion weights, pixel values of said pixel block and reference pixel values for said pixel block.

2. The method according to claim 1, wherein the step of determining said distortion weight comprises determining a distortion weight for a subgroup having an activity value representing a first activity to be lower than a distortion weight for a subgroup having an activity value representing a second activity that is comparatively lower than said first activity.

3. The method according to claim 1, wherein the step of defining said multiple subgroups comprises defining multiple non-overlapping subgroups of said pixel block, where each subgroup comprises 2^{m}×2^{m} pixels, wherein m is zero or a positive integer.

4. The method according to claim 1, wherein the step of determining said activity value comprises:
calculating, for each subgroup of said multiple subgroups and for each of multiple potential pixel neighborhoods comprising multiple pixels and encompassing said subgroup, a candidate activity value representative of a distribution of pixel values in said pixel neighborhood; and
selecting a smallest candidate activity value of said multiple candidate activity values as said activity value for said subgroup.

5. The method according to claim 4, wherein the step of calculating said candidate activity value comprises calculating said candidate activity value based on a sum of absolute differences in pixel values of vertically and horizontally neighboring pixels in said pixel neighborhood.

6. The method according to claim 4, further comprising identifying said multiple potential pixel neighborhoods as respective blocks of 2^{a}×2^{b} pixels encompassing said subgroup, wherein a,b are positive integers equal to or larger than one and a position of said subgroup within a potential pixel neighborhood of said multiple potential pixel neighborhoods is different from the respective positions of said subgroup within each of the other potential pixel neighborhoods of said multiple potential pixel neighborhoods.

7. The method according to claim 6, wherein identifying said multiple potential pixel neighborhoods comprises identifying each potential pixel neighborhood encompassing said subgroup and being positioned on a 2^{c}×2^{d} grid in said frame, wherein c,d are positive integers equal to or larger than one, c≦a and d≦b.

8. The method according to claim 1, wherein determining said distortion weight comprises:
a) comparing, for each subgroup of said multiple subgroups, said activity value determined for said subgroup with at least one activity threshold; and
b) determining, for each subgroup of said multiple subgroups, said distortion weight based on said comparison.

9. The method according to claim 8, further comprising determining a quantization parameter value for said pixel block, wherein determining step b) comprises:
i) determining, for each subgroup of said multiple subgroups, said distortion weight to be equal to a defined constant if said activity value determined for said subgroup exceeds an activity threshold; and
ii) determining, for each subgroup of said multiple subgroups, said distortion weight based on said quantization parameter value determined for said pixel block if said activity value determined for said subgroup is below said activity threshold.

10. The method according to claim 9, further comprising determining a Lagrange multiplier for said pixel block based on said quantization parameter value, wherein determining step ii) comprises determining, for each subgroup of said multiple subgroups, said distortion weight, k, to be
$$k = f \times \frac{{λ}_{N}}{{λ}_{M}}$$
if said activity value determined for said subgroup is below said activity threshold, wherein f is a factor equal to or larger than one, λ_{N} denotes said Lagrange multiplier for said pixel block and λ_{M} denotes a Lagrange multiplier for a neighboring pixel block in said frame.

11. The method according to claim 8, further comprising:
determining, for each pixel block in said frame, a block activity representative of a distribution of pixel values in said pixel block;
dividing the pixel blocks of said frame into multiple categories based on the respective quantization parameters determined for said pixel blocks;
identifying, for a category of said multiple categories, a pixel block having the highest block activity; and
calculating an activity threshold based the activity values determined for said identified pixel block.

12. The method according to claim 8, further comprising:
dividing the pixel blocks of said frame into multiple categories based on the respective quantization parameters determined for said pixel blocks;
calculating a respective percentage of said pixel blocks in said frame belonging to each of said multiple categories; and
calculating said at least one activity threshold based on said respective percentages.

13. The method according to claim 1, wherein estimating said distortion representation comprises calculating said distortion representation, D, as:
$$D = {\sum }_{i = 0}^{M - 1} {\sum }_{j = 0}^{N - 1} {k}_{ij} {\vert {p}_{ij} - {q}_{ij} \vert}^{n}$$
wherein pᵢⱼ denotes a pixel value at pixel position i,j within said pixel block, qᵢⱼ denotes a reference pixel value at pixel position i, j, kᵢⱼ denotes a distortion weight of a subgroup at pixel position i,j within said pixel block, n is a positive number equal to or larger than one and said pixel block comprises M×N pixels.

14. The method according to claim 1, further comprising:
determining a Lagrange multiplier for said pixel block based on a quantization parameter value assigned to said pixel block;
determining, for said pixel block, a rate value representative of a bit cost of an encoded version of said pixel block generated based on said quantization parameter value; and
calculating a rate-distortion value for said pixel block based on said distortion representation, said Lagrange multiplier and said rate value.

15. The method according to claim 14, further comprising:
pseudo-encoding said pixel block according to each encoding mode of a set of multiple available encoding modes;
calculating a rate-distortion value for each of said multiple available encoding modes;
selecting an encoding mode that minimizes said rate-distortion value among said multiple available encoding modes; and
generating an encoded version of said pixel block by encoding said pixel block according to said selected encoding mode.

16. A method of encoding a frame comprising multiple macroblocks of pixels, said method comprising:
calculating, for each macroblock, a macroblock activity representative of a distribution of pixel values within said macroblock; and
categorizing said multiple macroblocks as at least low activity macroblocks or high activity macroblocks based on said respective macroblock activities, wherein a macroblock categorized as a low activity macroblock is assigned a low quantization parameter value and a macroblock categorized as a high activity macroblock is assigned a high quantization parameter value that is larger than said low quantization parameter value, and for each macroblock of said multiple macroblocks:
determining, for each subgroup of at least one pixel out of multiple subgroups in said macroblock, an activity value representative of a distribution of pixel values in a pixel neighborhood comprising multiple pixels and encompassing said subgroup;
categorizing each of said multiple subgroups as low activity subgroups or high activity subgroups based on said respective activity values;
determining, for each low activity subgroup in a high activity macroblock, a distortion weight that is larger than a defined constant;
assigning, for each subgroup in a low activity macroblock and each high activity subgroup in a high activity macroblock, a distortion weight equal to said defined constant;
selecting the encoding mode of a set of multiple available encoding modes that minimizes a Lagrangian cost function J=D+λ×R, wherein D denotes a distortion that is equal to
$${\sum }_{i = 0}^{15} {\sum }_{j = 0}^{15} {k}_{ij} {\vert {p}_{ij} - {q}_{ij} \vert}^{n}$$
with pᵢⱼ denoting a pixel value at pixel position i,j within said macroblock, qᵢⱼ denotes a reconstructed pixel value at pixel position i,j within said macroblock, kᵢⱼ denotes a distortion weight of a subgroup at pixel position i,j within said macroblock and n is a positive number equal to or larger than one, λ denotes a Lagrange multiplier selected for said macroblock based on said quantization parameter value for said macroblock and R denotes a rate value representative of a bit cost of an encoded version of said macroblock obtained according to an encoding mode using said quantization parameter value for said macroblock; and
encoding said macroblock according to said selected encoding mode.

17. A device for generating a distortion representation for a pixel block of a frame comprising:
an activity calculator configured to calculate, for each subgroup of multiple subgroups in said pixel block, an activity value representative of a distribution of pixel values in a pixel neighborhood comprising multiple pixels and encompassing said subgroup, where each subgroup comprises at least one pixel of said pixel block;
a weight determiner configured to determine, for each subgroup of said multiple subgroups, a distortion weight based on said activity value calculated for said subgroup by said activity calculator; and
a distortion estimator configured to estimate a distortion representation for said pixel block based on said multiple distortion weights determined by said weight determiner, pixel values of said pixel block and reference pixel values for said pixel block.

18. The device according to claim 17, wherein said activity calculator is configured to calculate, for each subgroup of said multiple subgroups and for each of multiple potential pixel neighborhoods comprising multiple pixels and encompassing said subgroup, a candidate activity value representative of a distribution of pixel values in said pixel neighborhood, and select a smallest candidate activity value of said multiple candidate activity values as said activity value for said subgroup.

19. The device according to claim 18, wherein said activity calculator is configured to calculate said candidate activity value based on a sum of absolute differences in pixel values of vertically and horizontally neighboring pixels in said pixel neighborhood.

20. The device according to claim 18, wherein said activity calculator is configured to identify said multiple potential pixel neighborhoods as respective blocks of 2^{a}×2^{b} pixels encompassing said subgroup, wherein a,b are positive integers equal to or larger than one and a position of said subgroup within a potential pixel neighborhood of said multiple potential pixel neighborhoods is different from the respective positions of said subgroup within each of the other potential pixel neighborhoods of said multiple potential pixel neighborhoods.

21. The device according to claim 20, wherein said activity calculator is configured to identify each potential pixel neighborhood encompassing said subgroup and being positioned on a 2^{c}×2^{d} grid in said frame, wherein c,d are positive integers equal to or larger than one, c≦a and d≦b.

22. The device according to claim 17, wherein said weight determiner is configured to compare, for each subgroup of said multiple subgroups, said activity value determined for said subgroup with at least one activity threshold, and determine, for each subgroup of said multiple subgroups, said distortion weight based on said comparison.

23. The device according to claim 22, wherein said pixel block is assigned a quantization parameter value and said weight determiner is configured to determine, for each subgroup of said multiple subgroups, said distortion weight to be equal to a defined constant if said activity value determined for said subgroup exceeds an activity threshold, and determine, for each subgroup of said multiple subgroups, said distortion weight based on said quantization parameter value assigned to said pixel block if said activity value determined for said subgroup is below said activity threshold.

24. The device according to claim 23, wherein said pixel block is assigned a Lagrange multiplier selected for said pixel block based on said quantization parameter value and said weight determiner is configured to determine, for each subgroup of said multiple subgroups, said distortion weight, k, to be
$$k = f \times \frac{{λ}_{N}}{{λ}_{M}}$$
if said activity value determined for said subgroup is below said activity threshold, wherein f is a factor equal to or larger than one, λ_{N} denotes said Lagrange multiplier for said pixel block and λ_{M} denotes a Lagrange multiplier for a neighboring pixel block in said frame.

25. The device according to claim 22, further comprising:
a block activity calculator configured to calculate, for each pixel block in said frame, a block activity representative of a distribution of pixel values in said pixel block;
a block categorizer configured to divide the pixel blocks of said frame into multiple categories based on the respective quantization parameter values assigned for said pixel blocks;
a pixel block identifier configured to identify, for each category of said multiple categories, a pixel block having the highest block activity; and
a threshold calculator configured to calculate said at least one activity threshold based the activity values calculated for said pixel block identified by said pixel block identifier.

26. The device according to claim 22, further comprising:
a block categorizer configured to divide the pixel blocks of said frame into multiple categories based on the respective quantization parameter values assigned for said pixel blocks;
a percentage calculator configured to calculate a respective percentage of said pixel blocks in said frame belonging to each of said multiple categories; and
a threshold calculator configured to calculate said at least one activity threshold based on said respective percentages calculated by said percentage calculator.

27. The device according to claim 17, wherein said distortion estimator is configured to calculate said distortion representation, D, as:
$$D = {\sum }_{i = 0}^{M - 1} {\sum }_{j = 0}^{N - 1} {k}_{ij} {\vert {p}_{ij} - {q}_{ij} \vert}^{n}$$
wherein pᵢⱼ denotes a pixel value at pixel position i,j within said pixel block, qᵢⱼ denotes a reference pixel value at pixel position i, j, kᵢⱼ denotes a distortion weight of a subgroup at pixel position i,j within said pixel block, n is a positive number equal to or larger than one and said pixel block comprises M×N pixels.

28. The device according to claim 17, further comprising a rate distortion calculator configured to calculate a rate-distortion value for said pixel block based on said distortion representation, a Lagrange multiplier selected for said pixel block based on a quantization parameter value assigned to said pixel block and a rate value representative of a bit cost of an encoded version of said pixel block generated based on said quantization parameter.

29. An encoder configured to encode a pixel block and configured to pseudo-encode said pixel block according to each encoding mode of a set of multiple available encoding modes, said encoder comprises:
a device for estimating a distortion representation according to claim 28, wherein said rate-distortion calculator is configured to calculate a rate-distortion value for each of said multiple available encoding modes; and
a mode selector configured to select an encoding mode that minimizes said rate-distortion value among said multiple available encoding modes, wherein said encoder is configured to generate an encoded version of said pixel block by encoding said pixel block according to said encoding mode selected by said mode selector.

30. An encoder configured to encode a frame comprising multiple macroblocks of pixels, said encoder comprising:
a block activity calculator configured to calculate, for each macroblock, a macroblock activity representative of a distribution of pixel values for said macroblock; and
a block categorizer configured to categorize said multiple macroblocks as at least low activity macroblocks or high activity macroblocks based on said respective macroblock activities calculated by said block activity calculator;
a quantization selector configured to select, for each macroblock a quantization parameter based on said macroblock activity calculated by said block activity calculator, wherein a macroblock categorized as a low activity macroblock is assigned a low quantization parameter value by said quantization selector and a macroblock categorized as a high activity macroblock is assigned, by said quantization selector, a high quantization parameter value that is larger than said low quantization parameter value, and for each macroblock of said multiple macroblocks:
an activity calculator configured to calculate, for each subgroup of at least one pixel out of multiple subgroups in said macroblock, an activity value representative of a distribution of pixel values in a pixel neighborhood comprising multiple pixels and encompassing said subgroup;
a subgroup categorizer configured to categorize each of said multiple subgroups as low activity subgroups or high activity subgroups based on said respective activity values calculated by said activity calculator;
a weight determiner configured to determine, for each low activity subgroup in a high activity macroblock, a distortion weight that is larger than a defined constant and assign, for each subgroup in a low activity macroblock and each high activity subgroup in a high activity macroblock, a distortion weight equal to said defined constant; and
a mode selector configured to select the encoding mode of a set of multiple available encoding modes that minimizes a Lagrangian cost function J=D+λ×R, wherein D denotes a distortion that is equal to
$${\sum }_{i = 0}^{15} {\sum }_{j = 0}^{15} {k}_{ij} {\vert {p}_{ij} - {q}_{ij} \vert}^{n}$$
with pᵢⱼ denoting a pixel value at pixel position i,j within said macroblock, qᵢⱼ denotes a reconstructed pixel value at pixel position i,j within said macroblock, kᵢⱼ denotes a distortion weight of a subgroup at pixel position i,j within said macroblock and n is a positive number equal to or larger than one, λ denotes a Lagrange multiplier selected for said macroblock based on said quantization parameter value for said macroblock and R denotes a rate value representative of a bit cost of an encoded version of said macroblock obtained according to an encoding mode using said quantization parameter value for said macroblock, wherein said encoder is configured to encode said macroblock according to said encoding mode selected by said mode selector.
